(19) United States
(12) Patent Application Publication
(10) Pub. No.: US 2012/0277996 A1
(43) Pub. Date: Nov. 1, 2012

(54) METHOD TO DETERMINE REPRESENTATIVE ELEMENT AREAS AND VOLUMES IN POROUS MEDIA

(76) Inventors: NEIL F. HURLEY, BOSTON, MA (US); WEISHU ZHAO, QUINCY, MA (US); TUANFENG ZHANG, LEXINGTON, MA (US); JOHANNES J. BUITING, DIDAM (NL); NICOLAS X. LESEUR, BEZIERS (FR); MUSTAFA AL IBRAHIM, SAFWA (SA)

(21) Appl. No.: 13/407,542

(22) Filed: Feb. 28, 2012

Related U.S. Application Data
(60) Provisional application No. 61/447,419, filed on Feb. 28, 2011.

(51) Int. Cl. G06F 17/18; G06K 9/00

(52) U.S. Cl. 702/11; 702/128; 702/2; 382/109

(57) ABSTRACT

The subject disclosure relates to methods for determining representative element areas and volumes in porous media. Representative element area (REA) is the smallest area that can be modeled to yield consistent results, within acceptable limits of variance of the modeled property. Porosity and permeability are examples of such properties. In 3D, the appropriate term is representative element volume (REV). REV is the smallest volume of a porous media that is representative of the measured parameter.

### CROSS-REFERENCE TO RELATED APPLICATIONS

This application claims benefit of U.S. Provisional Patent Application Ser. No. 61/447419 filed on Feb. 28, 2011, entitled, “Method to Determine Representative Element Areas and Volumes in Porous Media.”

This application is also related to commonly assigned U.S. patent application entitled “Method to build 3D digital models of porous media using transmitted laser scanning confocal microscopy and multi-point statistics,” Ser. No. 12/459,414 (Attorney Docket No. 60.1912-US-NP), filed on Jul. 1, 2009, U.S. patent application entitled “Method to quantify discrete pore shapes, volumes, and surface areas using confocal profilometry,” Ser. No. 12/459,454 (Attorney Docket No. 60.1904-US-NP), filed on Jul. 1, 2009, U.S. patent application entitled “Method for characterizing a geological formation traversed by a borehole,” Ser. No. 12/384,945 (Attorney Docket No. 60.1818-US-NP), filed Apr. 10, 2009, U.S. patent application entitled “Method to generate numerical pseudocores using borehole images, digital rock samples, and multi-point statistics,” Ser. No. 12/384,721 (Attorney Docket No. 60.1824-US-NP), filed Apr. 8, 2009, U.S. patent application entitled “Multiscale digital rock modeling for reservoir simulation,” Ser. No. 13/036,770 (Attorney Docket No. IS11.0023-US-NP), filed Feb. 28, 2011, U.S. provisional patent application entitled “Methods to Build 3D Digital Models of Porous Media Using a Combination of High-And Low-Resolution Data and Multi-Point Statistics,” Ser. No. 61/447417 (Attorney Docket No. IS11.0024-US-PSP), filed Feb. 28, 2011; and U.S. provisional patent application entitled “Methods of using petrographic image analysis to determine capillary pressure in porous media,” Ser. No. 61/447434 (Attorney Docket No. IS11.0046-US-PSP), filed on Feb. 28, 2011, U.S. patent application entitled “Methods to Build 3D Digital Models of Porous Media Using a Combination of High-And Low-Resolution Data and Multi-Point Statistics,” Attorney Docket No.: IS11.0024-US-NP, filed herewith; and U.S. patent application entitled “Petrographic Image Analysis for Determining Capillary Pressure in Porous Media,” Attorney Docket No.: IS11.0046-US-NP, filed herewith. The content of each of the forgoing applications is incorporated herein by reference.

### BACKGROUND

Reservoir simulation covers at least 14 orders of magnitude, ranging from pore (nm to micron) to borehole (mm to m) to interwell (10's to 100's of m) to full-field scale (10's to 100's of km). Reservoir rocks are complex and heterogeneous at all scales. Multi-scale simulation is a major goal of the petroleum industry, and upscaling approaches have been proposed. For example, see Christie, M. A., 1996, Upscaling for reservoir simulation: JPT, v. 48, No. 11, p. 1004-1010, and Durlofsky, L. J., 2003, Upscaling of geocellular models for reservoir flow simulation: A review of recent progress: 7^{th} International Forum on Reservoir Simulation, Buhl/Baden-Baden, Germany, Jun. 23-27, p. 58. Upscaling is the process of converting a fine-scale geocellular model to a coarse simulation grid. Upscaling algorithms assign suitable values of porosity, permeability, and other flow functions to each grid block. Upscaling is needed because reservoir simulators cannot handle the large number of cells in typical geologic models.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

According to some embodiments, a method for determining an appropriate size for a representative sample of a heterogeneous material. The method includes: randomly selecting a plurality of sets of subsamples of the heterogeneous material, each of the subsamples within a set being of the same size; determining a property of the heterogeneous material for each of the subsamples; calculating a sample mean value for the property for the material; calculating a statistical value indicating variation from the sample mean, such as one standard deviation, for each of the sets of subsamples; extrapolating a plot of the calculated statistical values indicating variation for each set of subsamples versus the size of the subsamples from each set, to an intersection with and a plot of the sample mean; and selecting as the appropriate size for a representative sample a sample size corresponding to the intersection.

According to some embodiments, the plots are plotted on a log-log scale, and the extrapolated plot is a straight-line fit on the log-log scale. According to some embodiments, the subsamples within are non-overlapping. According to some embodiments, the heterogeneous material is a rock that is heterogeneous at a scale larger than individual grains and/or pores, and the determined property of the heterogeneous material is porosity.

According to some embodiments, a sample size is selected corresponding to the extrapolated plot being within an acceptable limit, such as +/−5%, of the mean plot.

According to some embodiments, the heterogeneous material is selected from a group consisting of: rock, soil, ceramics, filters, chemical mixtures, metals, oxides, catalysts, bone and human tissue.

According to some embodiments, a system for determining an appropriate size for representative sample of a heterogeneous material is described. The system includes a processing system adapted and programmed to randomly select a plurality of sets of subsamples of the heterogeneous material, each of the subsamples within a set being of the same size, determine a property of the heterogeneous material for each of the subsamples, calculate a sample mean value for the property for the material, calculate a statistical value indicating variation from the sample mean for each of the sets of subsamples, extrapolate a plot of the calculated statistical values indicating variation for each set of subsamples versus the size of the subsamples from each set, to an intersection with and a plot of the sample mean, and to select as the appropriate size for a representative sample a sample size corresponding to the intersection.

Further features and advantages of the subject disclosure will become more readily apparent from the following detailed description when taken in conjunction with the accompanying drawings.

### BRIEF DESCRIPTION OF THE DRAWINGS

The subject disclosure is further described in the detailed description which follows, in reference to the noted plurality of drawings by way of non-limiting examples of embodiments of the subject disclosure, in which like reference numerals represent similar parts throughout the several views of the drawings, and wherein:

FIG. 1 illustrates upscaling in heterogeneous rocks, according to some embodiments;

FIG. 2 illustrates a porosity representative element volume (REV), according to some embodiments;

FIG. 3 describes the basic workflow for statistical determination of representative element area (REA), according to some embodiments;

FIG. 4 illustrates a 2D confocal scan of a thin section of dolomitic wackestone and enlarged view, according to one embodiment; pores are light and minerals are dark;

FIG. 5 illustrates an example of a fine grid (white lines, 140×140 pixels) superimposed on a 2D binary image of a confocal scan of a thin section of dolomitic wackestone, according to one embodiment; pores are white and minerals are black;

FIG. 6 illustrates an example of a coarse grid (white lines, 555×555 pixels) superimposed on the 2D binary image of a confocal scan of the thin section of dolomitic wackestone shown in FIG. 5; pores are white and minerals are black;

FIG. 7 illustrates a cross plot of fractional porosity vs. subsample area (in square pixels) for the sample in FIGS. 5 and 6, according to some embodiments;

FIG. 8 illustrates a log-log cross plot of fractional porosity vs. subsample area (in square pixels) for the sample in FIGS. 5 and 6, according to some embodiments;

FIG. 9 describes the basic workflow for statistical determination of representative element volume (REV), according to some embodiments; and

FIG. 10 shows systems for determining the REA and/or REV of a heterogeneous material, according to some embodiments.

### DETAILED DESCRIPTION

The particulars shown herein are by way of example and for purposes of illustrative discussion of the embodiments of the subject disclosure only and are presented in the cause of providing what is believed to be the most useful and readily understood description of the principles and conceptual aspects of the subject disclosure. In this regard, no attempt is made to show structural details of the subject disclosure in more detail than is necessary for the fundamental understanding of the subject disclosure, the description taken with the drawings making apparent to those skilled in the art how the several forms of the subject disclosure may be embodied in practice. Further, like reference numbers and designations in the various drawings indicate like elements.

Geological heterogeneity is defined as the variation in rock properties as a function of location within a reservoir or formation. Geocellular models are layered, gridded 3D models that capture geological heterogeneities, and commonly have millions of cells. Upscaling, which is the process of converting modeled rock properties from fine to coarse scales, assigns suitable values of porosity, permeability, and other fluid flow transport properties to each coarse grid block. Upscaling is needed because reservoir simulators cannot handle the large number of cells in typical geocellular models.

Representative element volume (REV) is the smallest volume that can be modeled to yield consistent results, within acceptable limits of variance of the modeled property. Porosity and permeability are examples of such properties. In 2D, the appropriate term is representative element area (REA). REA is the smallest area of a porous media that is representative of the measured parameter.

According to some embodiments, REA's and REV's are determined using an iterative process, whereby variance in the given parameter is measured for successively larger sample areas or volumes. REA and REV are the areas and volumes, respectively, where the standard deviation of variance from the sample mean is either zero or an acceptably low value. In practice, according to some embodiments, REA and REV are determined by cross plotting the measured property vs. stepwise subsample areas or volumes. Cross plots show decreasing variance, measured as standard deviation from the known mean value, as a function of increasing area or volume of the subsamples. It has been found that when log-log cross plots are made, standard deviations from mean porosity generally lie on a straight line, i.e., a power-law function that can be extrapolated to the known laboratory-derived, sample-mean porosity or permeability to determine REV or REA. REV for porosity, permeability, or other parameters may vary. In that case, the final model should use the largest REV.

According to some embodiments, a method is described to precisely determine REV and REA in porous media. The approach can be applied at any scale, ranging from sub-micron scale pore networks to kilometer-scale interwell volumes. REVs and REAs are important because suitably sized samples to capture heterogeneity in the measured parameter can be chosen. As an added advantage, REA and REV quantify the largest areas or volumes that need to be modeled. In short, there is no need to model areas or volumes larger than the REA or REV, because results will be the same. Therefore, we can put an upper size limit on the upscaled area or volume needed for reservoir simulation.

Heterogeneity and Upscaling. Heterogeneity is defined as variation in rock properties as a function of location within a reservoir or formation. Many reservoirs are heterogeneous because mineralogy, grain type and size, depositional environment, porosity, permeability, natural fractures, faults, channels, and other attributes vary from place to place. Heterogeneity causes problems in formation evaluation and reservoir simulation because reservoirs occupy enormous volumes, but there is limited core and log control.

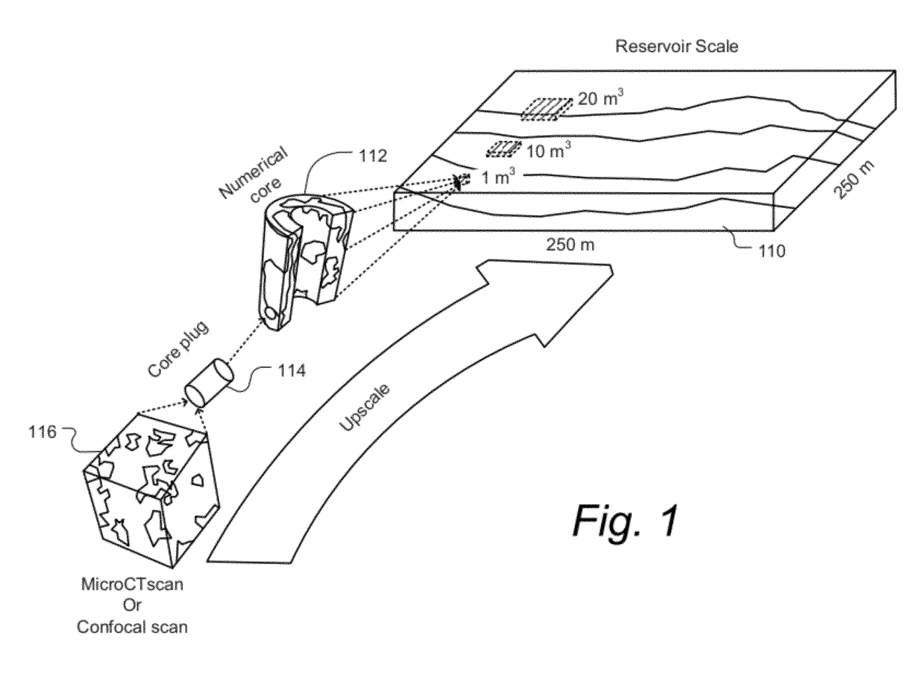

FIG. 1 illustrates upscaling in heterogeneous rocks, according to some embodiments. A typical grid block 110 used in a reservoir simulator is 250×250×1 m in size. Borehole-scale numerical cores 112 represent rock volumes on the cubic-meter scale. Core plugs 114 and microCTscans or confocal scans 116 represent even smaller volumes. From FIG. 1 the heterogeneity challenges can be seen from the viewpoint of a digital rock modeler.

A geocellular model is a layered, gridded 3D model. Layers can have zero thickness, as in the case of bed pinch outs or truncations. Layers can be thin, like the spacing of log measurements, or they can be thicker, to reflect the known thickness of rock layers. Geocellular models capture geologic-scale heterogeneities, and commonly have millions of cells.

Upscaling is the process of converting rock properties from fine scales to coarser scales. Upscaling algorithms assign suitable values of porosity, permeability, and other fluid flow-transport properties to each coarser grid block. See for example, Lasseter, T. J., Waggoner, J. R., and Lake, L. W., 1986, “Reservoir heterogeneities and their influence on ultimate recovery,” in Lake, L. W., and Carroll, H. B., Jr., eds., Reservoir Characterization: Academic Press, Orlando, Fla., p. 545-559, Christie, M. A., 1996, “Upscaling for reservoir simulation:” JPT, v. 48, No. 11, p. 1004-1010 and Durlofsky, L. J., 2003, “Upscaling of geocellular models for reservoir flow simulation:” A review of recent progress: 7th International Forum on Reservoir Simulation, Buhl/Baden-Baden, Germany, June 23-27, p. 58. Upscaling is necessary because reservoir simulators cannot handle the large number of cells in typical geocellular models.

Digital Models of Rocks and Pores. There are many examples of numerical rock models built using techniques including reconstructions made from 2D thin sections or scanning-electron microscope (SEM) images, computer-generated sphere packs, laser scanning fluorescence microscopy, and various types of CT scans (conventional, micro CT, nano CT, and synchrotron-computed microtomography).

The most common way to visualize pore systems in 3D is from CT scans. Samples for micro CT are selected based on whole-core CT scans. Whole-core CT scans provide an overall view of heterogeneity in the cored interval. Based on CT numbers, which are direct indications of core density, sample locations from various areas of core are marked. Samples are then cut using appropriate tools. No special procedure is needed to clean the samples before micro CT scans.

Microtomography employs X-rays to acquire cross-sections of a 3D object that can be used to create virtual models. Micro CT scanners are usually small in design compared to medical scanners, and are ideally suited for imaging smaller objects such as core samples a few millimeters in size. Micro CT scanners are used to obtain exact 3D details about rock morphology by avoiding approximations needed to reconstruct 3D images via process-based or statistical methods. Micro CT scanners typically achieve a resolution of about 1 to 5 microns. For further analysis, with resolution below the micron range, nanoCT scanners may be used.

Laser scanning fluorescence microscopy (LSFM) provides a high-resolution (about 0.25 micron) technique to build 3D digital rock models. Confocal and multiphoton techniques are most common, although the emerging field of super-resolution fluorescence microscopy may provide improved images of rocks and other porous media, down to a few nm to 10's of nm in scale. See “Huang, B., Bates, M., and Zhuang, X., 2009, “Super-resolution fluorescence microscopy:” Annual Review of Biochemistry, v. 78, p. 993-1016.” Such techniques enhance the resolution of fluorescence microscopy using patterned excitation or single molecule localization of fluorescence.

Confocal microscopy, the most common type of LSFM, uses point illumination and a pinhole placed in front of a detector to remove out-of-focus light. Because each measurement is a single point, confocal devices perform scans along grids of parallel lines to provide 2D images of sequential planes at specified depths within a sample.

Depth of penetration of LSFM is limited because reflected light is absorbed and scattered by material above the focal plane. Our experiments have successfully imaged depths as great as 500 microns using pore casts of carbonate rocks, where the rock material has been removed with acid. Fortunately, areal coverage is not limited because tiled scans can be made of relatively large areas (10's of mm²) of polished sections of rock.

Multiphoton microscopy uses two-photon excitation to image living tissue to a very high depth, about one millimeter. See “Wikipedia, 2010b, website http://en.wikipedia.org/wiki/Two-photon_excitation_microscopy, accessed on Oct. 23, 2010”. Like confocal microscopy, this technique excites fluorescent dyes injected into rocks. “The principal is based on the idea that two photons of comparably lower energy than needed for one photon excitation can also excite a fluorophore in one quantum event. Each photon carries approximately half the energy necessary to excite the molecule. An excitation results in the subsequent emission of a fluorescence photon, typically at a higher energy than either of the two excitatory photons.” Resolution is diffraction-limited to about 250nm, similar to confocal microscopy. Confocal and multiphoton microscopy is widely used in the life sciences and semiconductor industries.

Representative Element Volumes. Representative element volumes (REV) provide a new way to deal with heterogeneity and upscaling issues in reservoir modeling. See “Qi, D., 2009, “Upscaling theory and application techniques for reservoir simulation:” Lambert Academic Publishing, Saarbrucken, Germany, 244 p″ (hereinafter “Qi 2009”). In summary, REV is the smallest volume that can be modeled to yield consistent results, within acceptable limits of variance of a modeled property, such as porosity. Using this approach, one can upscale rock properties from fine to coarse scales. The smallest volume to be modeled is determined, the flow model is run, and the results are used in the next larger-scale simulations. Once an REV has been modeled, there is no need to model larger volumes because heterogeneity has been captured for that particular rock type at that scale.

The concept of REV was discussed in 1972. See “Bear, J., 1972, “Dynamics of fluids in porous media:” Elsevier, New York, 746 p” (hereinafter “Bear 1972”). Bear defined ΔUᵢ as a volume in a porous media, with a centroid of P. ΔUᵢ is considered to be much larger than a single pore or grain. ΔUᵥ is the volume of void space, and nᵢ is the ratio of void space to volume, i.e., the fractional porosity. At large values of ΔUᵢ, there are minimal fluctuations of porosity as a function of volume. However, as volume decreases, fluctuations in porosity increase, especially as ΔUᵢ approaches the size of a single pore, which has fractional porosity of 1. If the centroid P happens to lie in a grain, porosity is 0 when ΔUᵢ=0. The value ΔUₒ is defined as the REV, below which fluctuations of porosity are significant, and above which fluctuations of porosity are minimal. In brief, the dimensions of ΔUₒ are sufficient so that “the effect of adding or subtracting one or several pores has no significant influence on the value of n” (Bear, 1972).

Using the REV approach, the porous medium is replaced by “a fictitious continuum: a structureless substance, to any point of which we can assign kinematic and dynamic variables and parameters that are continuous functions of the spatial coordinates of the point and of time” (Bear, 1972). Note that the REV for porosity may differ from the REV for permeability or other parameters. Also, the REV for static vs. dynamic properties may vary. In practice, the best method is to use the largest REV determined using various approaches.

How can we determine REV for a rock property, such as porosity? Conceptually, one could acquire or model a large volume, subsample that volume, and compute variance in porosity as a function of subsample volume. This could be done at any scale, ranging from pores to boreholes to interwell volumes to large oil and gas fields.

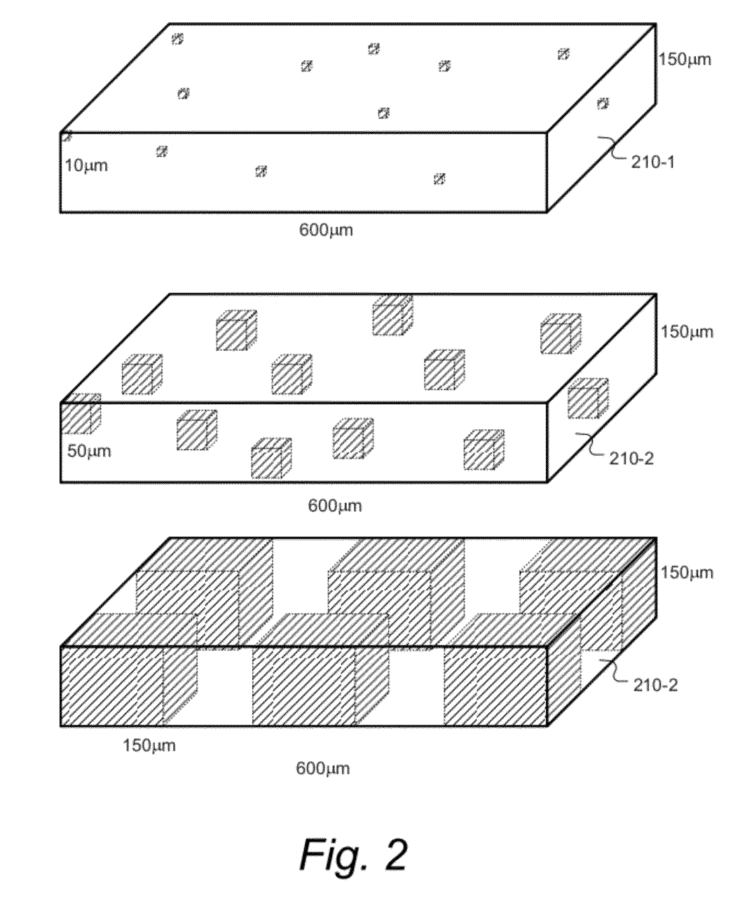

FIG. 2 illustrates a porosity representative element volume (REV), according to some embodiments. A pore-scale modeled volume of 600×600μ in area, 150μ in thickness is shown. The same volume can be divided into smaller sub-volumes of different size. For example, modeled volume 210-1 is shown with 10 μm cubes extracted, modeled volume 210-2 is shown with 50 μm cubes extracted, and modeled volume 210-3 is shown with 150 μm cubes extracted. In each case the porosities of the sub-volumes could be determined. All sub-volumes, regardless of scale, should be independent, non-overlapping volumes. If porosity variance is less than a chosen cutoff, for example +/−5%, then that volume can be used as the REV. For the purpose of flow modeling, the REV yields representative results.

Most reservoir engineers have heard rocks, especially carbonates, described as “so heterogeneous, they are homogeneous.” Fundamentally, this is a statement about REV's. Below a certain sample size, rocks are heterogeneous and there is considerable dispersion or variance in rock properties (for example, see “Greder, H. N., Biver, P. Y., Danquigny, J., and Pellerin, F. M., 1996, “Determination of permeability distribution at log scale in vuggy carbonates:” Paper B B, SPWLA 37th Annual Logging Symposium, June 16-19, 14 p”). Above a certain sample size, dispersion is reduced to an acceptable level, and this sample size is the REV.

Representative Element Areas. An analogous term for REV in 2D, which is REA (representative element area) was defined. See “Norris, R. J., and Lewis, J. J. M., 1991, “The geological modeling of effective permeability in complex heterolithic facies:” SPE Preprint 22692, Presented at the 66th Annual Technical Conference and Exhibition, Dallas, Tex., October 6-9, p. 359-374” (hereinafter “Norris 1991”). Norris 1991 applied the concept to modeling of effective permeability from scanned outcrop photos in heterolithic rocks. Basically, REA is the smallest area of a rock that is representative of the measured rock property. REA and REV measure area and volume, respectively. Both terms allow us to capture heterogeneity in rock properties.

REA is determined using an iterative process, whereby variance in a given parameter, such as porosity, is measured for successively larger sample areas. REA is determined as the area where the standard deviation of the variance from the sample mean is less than a chosen cutoff, for example +/−5%. Sample mean could be laboratory-derived core-analysis porosity.

Representative element volumes (REV) and representative element areas (REA) provide new applications in reservoir modeling. In summary, REVs and REAs are the smallest volumes or areas that can be modeled to yield consistent results, within acceptable limits of variance of the modeled property, such as porosity or permeability. Using this approach, the smallest volume or area to be modeled can be determined, the flow model is run, and the results are used to upscale to larger-scale simulations. This subject disclosure limits the required size of reservoir models, because REV and REA are fixed volumes and areas for particular rock types. Although we apply the subject disclosure to rocks, the same techniques apply to any porous media at any scale of resolution.

The subject disclosure discloses methods to determine REA or REV, with digital rock samples as examples. Methods can be applied to models at any scales, provided these models are available and a benchmark property value can be predefined. In our digital rock examples, models are segmented rock images and the benchmark property value is the porosity measured.

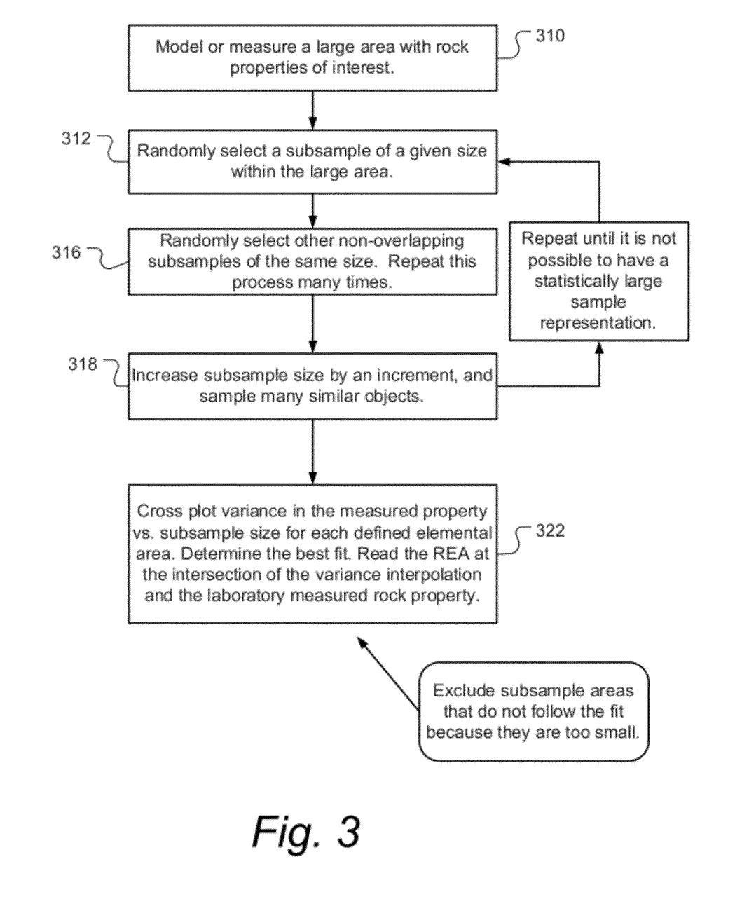

FIG. 3 describes the basic workflow for statistical determination of REA, according to some embodiments. In block 310, a large area with rock properties of interest is modeled or measured. In one non-limiting example, 2D LSFM scans of a thin section could be used as the measured data. In block 312, a subsample of a given size within the large area is randomly selected. In block 316 other non-overlapping subsamples of the same size are randomly selected. According to some embodiments, the process is repeated once or a plurality of times. In block 318, the subsample size is increased by an incremental area value. This process is repeated until it is not possible to have a statistically large subsample representation. For example, the process could be stopped when there are fewer than 30 non-overlapping subsamples. In block 322, a cross plot of variance in the measured property vs. subsample size is made for each defined subsample area. Extrapolation, if necessary, is performed to the sample mean of the measured property using the appropriate fit. For example, plot log₁₀ of the rock property vs. log₁₀ of the subsample size. If a straight-line power-law function is observed, extrapolate this (if necessary) to the sample mean to detect REA. When one standard deviation of the variance is within acceptable limits (for example, ±5% of the sample mean), this is the REA for the rock-property. Exclude subsample areas that do not follow the fit because they are too small.

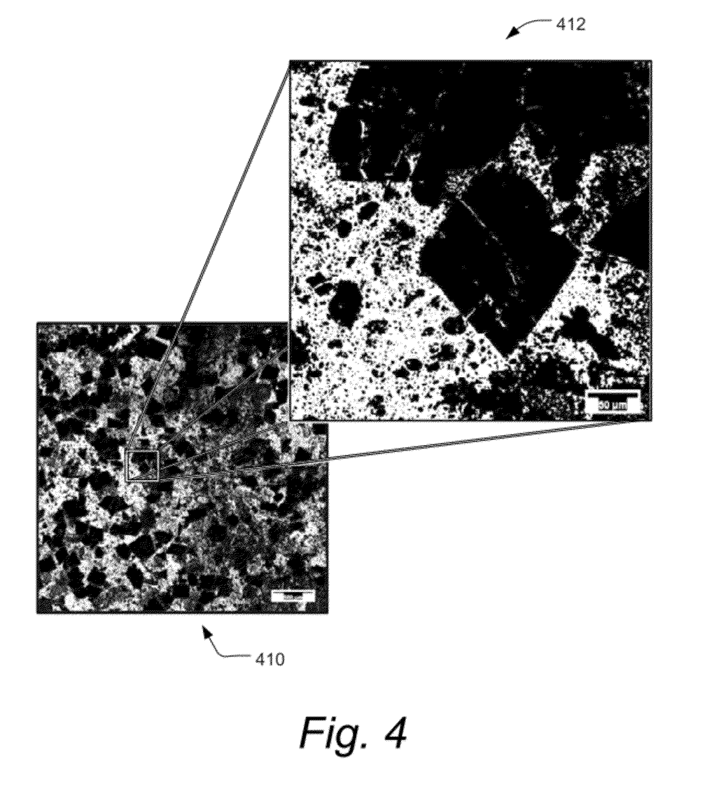

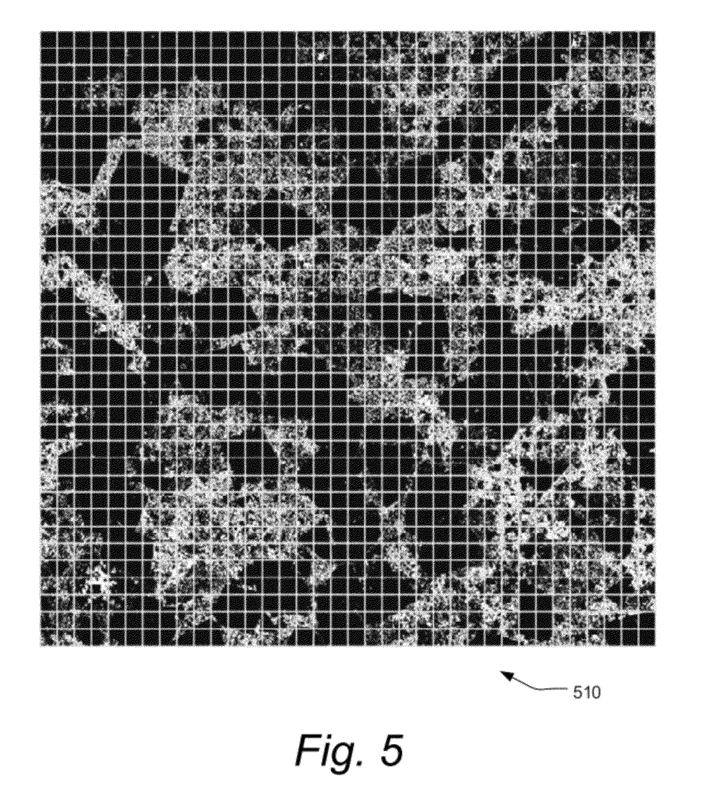

According to one embodiment, the application of REA is described using a thin section of dolomitic wackestone. FIG. 4 illustrates a 2D confocal scan of a thin section of dolomitic wackestone (410) and enlarged view (412). Pores are light and minerals are dark. Large black rhombs are dolomite crystals. FIG. 5 illustrates an example of a fine grid (white lines, 140×140 pixels) superimposed on a 2D confocal scan 510 of a thin section of dolomitic wackestone, according to one embodiment. A threshold of measured core-analysis porosity has been applied to make a binary image. Pores are white and minerals are black. Large black rhombs are dolomite crystals. The porosity of each non-overlapping subsample can be computed to examine variance from the sample mean, i.e., core-analysis porosity.

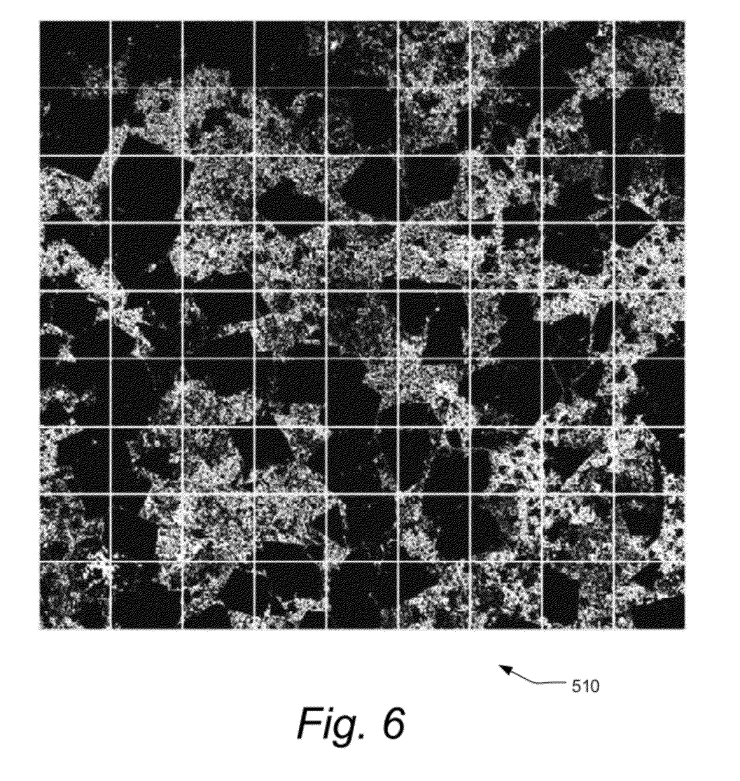

FIG. 6 illustrates an example of a coarse grid (white lines, 555×555 pixels) superimposed on the 2D confocal scan 510 of a thin section of dolomitic wackestone. A threshold of measured core-analysis porosity has been applied to make a binary image. Pores are white and minerals are black. Large black rhombs are dolomite crystals. The porosity of each non-overlapping subsample can be computed to examine variance from the sample mean, i.e., core-analysis porosity.

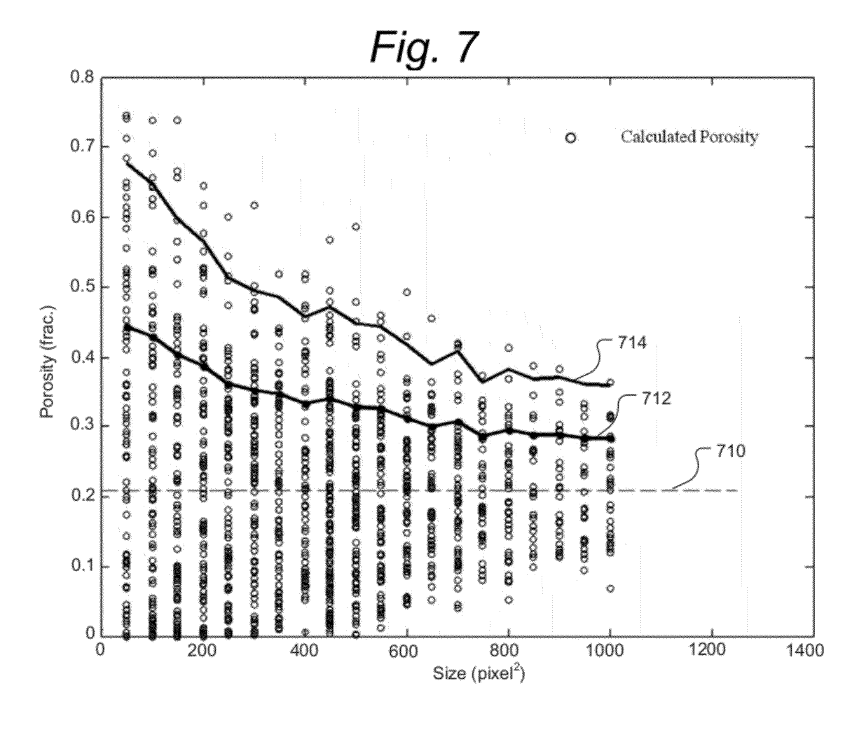

FIG. 7 illustrates a cross plot of fractional porosity vs. subsample area (in square pixels) for the sample in FIGS. 5 and 6. As subsample area increases, variance in porosity decreases. All subsamples are non-overlapping areas. The process is halted at 1000×1000 pixels, when there are 30 or fewer independent subsamples. The line 710 is core-analysis porosity, which is the sample mean. The line 712 is one standard deviation (STD), and the line 714 is 2 standard deviations about the mean. According to some embodiments an analytical expression is used to extrapolate the line 712 to the point where variance is within +/−5% of the sample mean. That area is termed the REA, according to some embodiments.

Many phenomena in nature behave in a fractal manner, and their frequency distributions follow a power-law fit. For example, see “Mandelbrot, B. B., 1967, “How long is the coast of Britain? Statistical self-similarity and fractional dimension:” Science, v. 156, p. 636-638). Fractal behavior occurs with fractures (for example, see Marrett, R., Ortega, O. J., and Kelsey, C. M., 1999, “Extent of power-law scaling for natural fractures in rocks”: Geology, v. 27, p. 799-802.) and pore-size distributions in rocks (for example, see Thompson, A. H., 1991, “Fractals in rock physics:” Annual Review of Earth and Planetary Sciences, v. 19, p. 237-262. and Angulo, R. F., Alvarado, V., and Gonzalez, H., 1992, “Fractal dimensions from mercury intrusion capillary tests:” SPE Preprint 23695, Presented at the Second Latin American Petroleum Engineering Conference, Caracas, Venezuela, March 8-11, p. 255-263.). Log-log cross plots of cumulative pore-size distributions vs. pore diameter are commonly straight lines. See “Li, K., 2004, “Characterization of rock heterogeneity using fractal geometry:” SPE Preprint 86975, Presented at SPE International Thermal Operations and Heavy Oil Symposium and Western Regional Meeting, 16-18 March, Bakersfield, Calif., 7 p”.

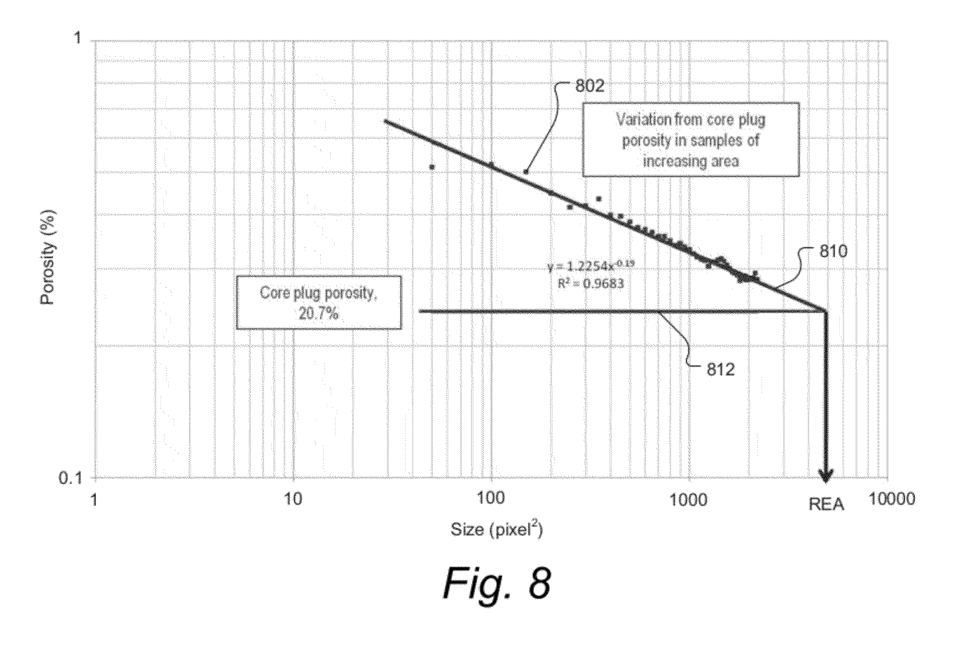

It has been found that the standard deviation (STD) function of porosity for different tile sizes follows a power-law distribution when plotted on a log-log scale. When the straight-line fit is extrapolated to the sample mean, REA can be precisely determined (FIG. 8). Some sampled areas are large enough so no extrapolation is necessary.

FIG. 8 illustrates a log-log cross plot of fractional porosity vs. subsample area (in square pixels) for the sample in FIGS. 5 and 6, according to some embodiments. Data points are shown in square markers such as marker 802. As subsample area increases, variance in porosity decreases. All subsamples are non-overlapping areas. The line 812 is core-analysis porosity, which is the sample mean. The line 810 is the best-fit to one standard deviation from the sample mean. When the line 810 is extrapolated to the line 812, this gives the corresponding area for the REA as shown.

Care should be taken with power-law fitting. It should be applied to the tail of the STD function. Excluding data that do not follow the power-law distribution is essential for a good interpolation. See Clauset, A., Shalizi, C. R., and Newman, M. E. J., 2009, “Power-law distributions in empirical data:” SIAM Review, v. 51, No. 4, p. 661-703. (hereinafter “Clauset 2009”). It has been found that tile sizes that produced porosity values of 0 or 1 do not follow the power law, i.e., a straight line will not occur when plotted on log-log scale. These tile sizes correspond to sizes smaller than a single pore or grain.

There is also a limit on the largest tile size. Using a small number of tiles for a given tile size is statistically inaccurate. The approach here is to use at least 30 non-overlapping tiles for a given STD value. This reduces fluctuations that are commonly associated with power-law distributions at the end of the function tail (Clauset 2009).

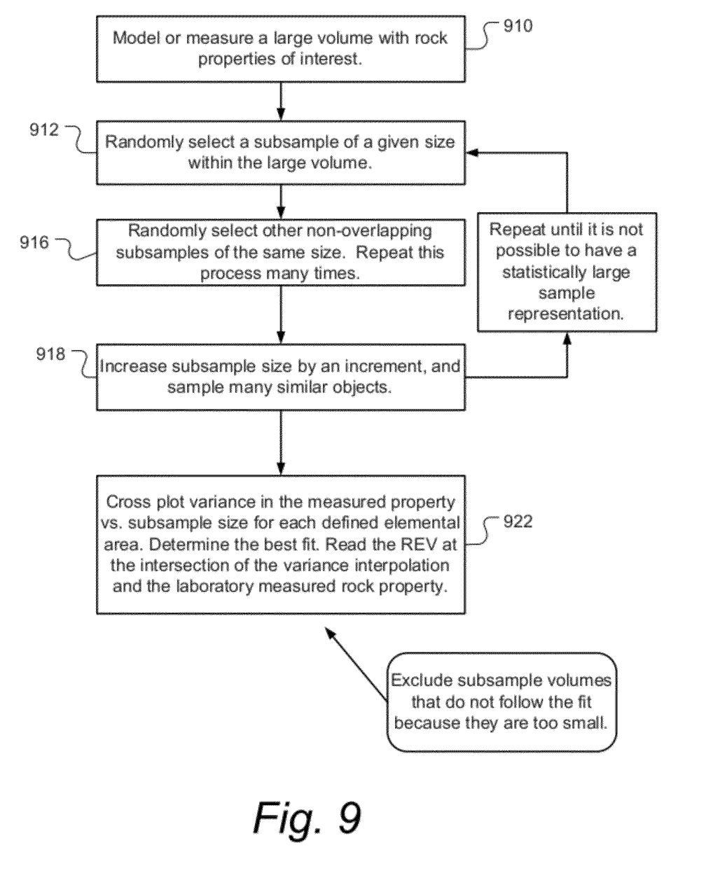

FIG. 9 describes the basic workflow for statistical determination of REV, according to some embodiments. In block 910, a large volume with rock properties of interest is modeled or measured. In one non-limiting example, 3D LSFM scans of a thin section could be used as the measured data. In block 912, a subsample of a given size within the large volume is randomly selected. In block 916, other non-overlapping subsamples of the same size are randomly selected. According to some embodiments, the process is repeated once or a plurality of times. In block 918, the subsample size is increased by an increment volume value. This process is repeated until it is not possible to have a statistically large subsample representation. For example, the process could be stopped when there are fewer than 30 non-overlapping subsamples. In block 922, a cross plot of variance in the measured property vs. subsample size is made for each defined subsample volume. Extrapolation, if necessary, is performed to the sample mean of the measured property using the appropriate fit. For example, plot log₁₀ of the rock property vs. log₁₀ of the subsample size. If a straight-line power-law function is observed, extrapolate this (if necessary) to the sample mean to detect REV. When one standard deviation of the variance is within acceptable limits (for example, ±5% of the sample mean), this is the REV for the rock-property. Subsample areas that do not follow the fit because they are too small are excluded.

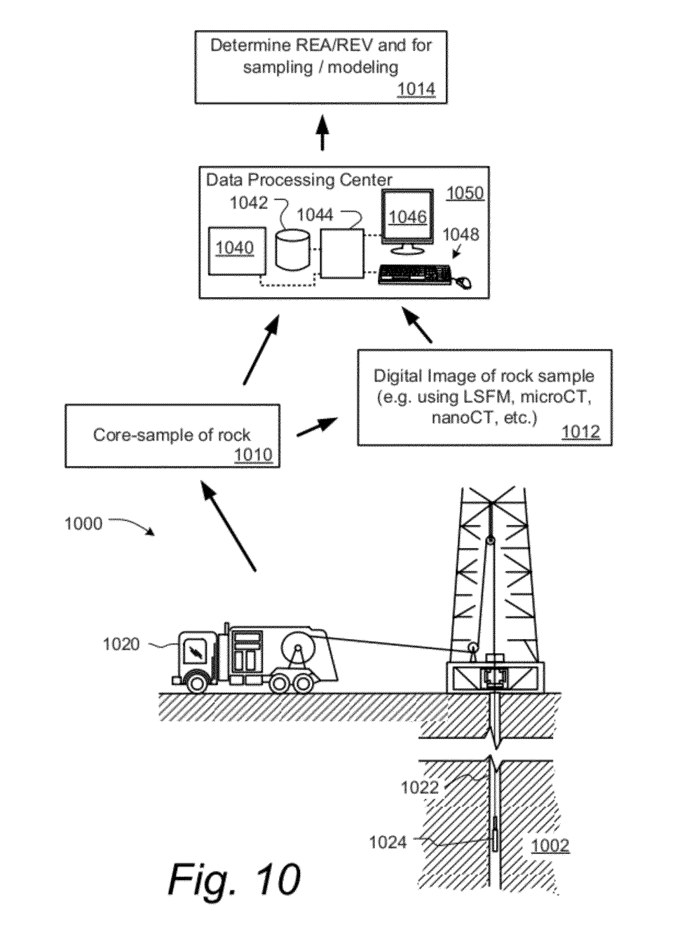

FIG. 10 shows systems for determining the REA and/or REV of a heterogeneous material, according to some embodiments. An acquired core-sample of the rock 1010 is digitally imaged in block 1012 using, for example a high resolution system (such as from LSFM, SEM, TEM, AFM, VSI, etc.). According to some embodiments lower resolution imaging techniques, such as using micro CT, conventional CT and/or macro digital photography can be made in addition to or in place of the high resolution images. The image data are transmitted to a processing center 1050, which includes one, or more central processing units 1044 for carrying out the data processing procedures as described herein, as well as other processing. The processing center includes a storage system 1042, communications and input/output modules 1040, a user display 1046 and a user input system 1048. According to some embodiments, the processing center 1050 may be located in a location remote from the acquisition site of the petrographic data. According to some embodiments other measurements, such as direct porosity measurement are taken on the core sample 1010 or a subsample thereof. According to yet other embodiments, imaging techniques other than based on the core sample, such as FMI, seismic, sonic, etc. are made of the borehole wall and/or the surrounding subterranean rock formation. In FIG. 10 data and/or samples from a subterranean rock formation 1002 are gathered at wellsite 1000 via a wireline truck 1020 deploying a wireline tool 1024 in well 1022. According to some embodiments, wireline tool 1024 includes a core-sampling tool to gather one or more core samples from the formation 1002. As described herein the data processing center is used to determine the REA and/or REV (1014) of the sampled heterogeneous material. Although the system in FIG. 10 is shown applied to the example of digital rock images of a subterranean formation, in general the described techniques can be applied to any heterogeneous material.

While the subject disclosure is described through the above embodiments, it will be understood by those of ordinary skill in the art that modification to and variation of the illustrated embodiments may be made without departing from the inventive concepts herein disclosed. Moreover, while the preferred embodiments are described in connection with various illustrative structures, one skilled in the art will recognize that the system may be embodied using a variety of specific structures. Accordingly, the subject disclosure should not be viewed as limited except by the scope and spirit of the appended claims.

What is claimed is:

1. A method for determining an appropriate size for a representative sample of a heterogeneous material, the method comprising:
randomly selecting a plurality of sets of subsamples of the heterogeneous material, each of the subsamples within a set being of the same size;
determining a property of the heterogeneous material for each of the subsamples;
calculating a sample mean value for the property for the material;
calculating a statistical value indicating variation from the sample mean for each of the sets of subsamples;
extrapolating a first plot of the calculated statistical values indicating variation for each set of subsamples versus the size of the subsamples from each set, to an intersection with and a second plot of the sample mean; and
selecting as the appropriate size for a representative sample a sample size corresponding to the intersection.

2. A method according to claim 1 wherein the statistical value indicating variation is one standard deviation.

3. A method according to claim 1 wherein the first plot and second plot are plotted on a log-log scale, and the first plot is a straight-line fit on the log-log scale.

4. A method according to claim 1 wherein the sample mean is determined from a sample of the material independently from the determined properties of the subsamples.

5. A method according to claim 1 wherein the sample mean is determined based on the calculated properties of the subsamples.

6. A method according to claim 1 wherein the selected size for the representative sample is a smallest area over which a measurement of the property can be made that yields a value representative of the heterogeneous material.

7. A method according to claim 1 wherein each set of subsamples has different subsample sizes from each other set of subsamples.

8. A method according to claim 1 wherein the subsamples within a set correspond to non-overlapping areas or volumes within the heterogeneous material.

9. A method according to claim 1 wherein the heterogeneous material is rock.

10. A method according to claim 9 wherein the determined property of the heterogeneous material is porosity.

11. A method according to claim 10 wherein the rock is heterogeneous at a scale larger than individual grains and/or pores.

12. A method according to claim 11 wherein the plurality of sets of subsamples are gathered from a digital image generated using one or more techniques selected from a group consisting of: thin section laser scanning fluorescence microscopy, thick section laser scanning fluorescence microscopy, transmitted laser scanning fluorescence microscopy, conventional CTscan, microCTscan, nanoCTscan, synchrotron-computed microtomography, and focused ion beam-scanning electron microscopy.

13. A method according to claim 10 wherein the plurality of sets of subsamples are gathered from a 2D digital image and the sample mean is determined from an independent core-analysis porosity measurement on the heterogeneous material.

14. A method according to claim 9 wherein the heterogeneous material is a subterranean rock formation.

15. A method according to claim 14 wherein the subterranean rock formation is hydrocarbon bearing and penetrated by a borehole, and the subsamples are from one or more images of a wall of the borehole made using a downhole tool.

16. A method according to claim 1 wherein the selecting includes selecting a sample size corresponding to the extrapolated first plot being within an acceptable limit of the second plot.

17. A method according to claim 16 wherein the acceptable limit is +/−5% of the second plot.

18. A method according to claim 1 wherein the first plot is a power-law fit to the calculated statistical values.

19. A method according to claim 1 further comprising modeling the heterogeneous material using one or more representative samples having the determined size.

20. A method according to claim 1 wherein the heterogeneous material is selected from a group consisting of: rock, soil, ceramics, filters, chemical mixtures, metals, oxides, catalysts, bone and human tissue.

21. A method according to claim 1 wherein the size for the representative sample is an area and corresponds to an REA.

22. A method according to claim 1 wherein the size for the representative sample is a volume and corresponds to an REV.

23. A system for determining an appropriate size for a representative sample of a heterogeneous material, the system including a processing system adapted and programmed to randomly select a plurality of sets of subsamples of the heterogeneous material, each of the subsamples within a set being of the same size, determine a property of the heterogeneous material for each of the subsamples, calculate a sample mean value for the property for the material, calculate a statistical value indicating variation from the sample mean for each of the sets of subsamples, extrapolate a first plot of the calculated statistical values indicating variation for each set of subsamples versus the size of the subsamples from each set, to an intersection with and a second plot of the sample mean, and to select as the appropriate size for a representative sample a sample size corresponding to the intersection.

24. A system according to claim 23 wherein the subsamples within a set correspond to non-overlapping areas on the heterogeneous material, the statistical value indicating variation is one standard deviation, and the first plot and second plot are plotted on a log-log scale, and the first plot is a straight-line fit on the log-log scale.

25. A system according to claim 23 wherein the heterogeneous material is a subterranean hydrocarbon rock formation and the determined property of the heterogeneous material is porosity.

26. A system according to claim 23 further comprising modeling the heterogeneous material using one or more representative samples having the determined size.

27. A system according to claim 23 wherein the size for the representative sample is an area and corresponds to an REA

28. A system according to claim 23 wherein the size for the representative sample is a volume and corresponds to an REV.

29. A method for determining an appropriate size for a representative sample of a heterogeneous subterranean rock formation, the method comprising:
randomly selecting a plurality of sets of subsamples from an image of a portion of the rock formation, each of the subsamples within a set being of the same size;
determining a porosity of the rock from each of the subsamples;
calculating a sample mean value for the porosity;
calculating a statistical value indicating variation from the sample mean for each of the sets of subsamples;
extrapolating a first plot of the calculated statistical values indicating variation for each set of subsamples versus the size of the subsamples from each set, to an intersection with and a second plot of the sample mean; and
selecting as the appropriate size for a representative sample a sample size corresponding to the intersection.

30. A method according to claim 29 further comprising modeling at least a portion of the rock formation using one or more representative samples having the determined appropriate size.
